(19) United States
(12) Patent Application Publication
(10) Pub. No.: US 2020/0349347 A1
(43) Pub. Date: Nov. 5, 2020

(54) SYSTEMS AND METHODS FOR MONITORING AND RECOGNIZING HUMAN ACTIVITY

(71) Applicant: Cherry Labs Inc., Wilmington, DE (US)

(72) Inventor: Vasily Morzhakov, Wilmington, DE (US)

(21) Appl. No.: 16/736,200

(22) Filed: Jan. 7, 2020

Related U.S. Application Data
(60) Provisional application No. 62/789,217, filed on Jan. 7, 2019.

(51) Int. Cl. G06K 9/00; G06N 20/00; G06T 11/20; G06K 9/62

(52) U.S. Cl. CPC G06K 9/00342; G06N 20/00; G06T 11/203; G06K 9/00288; G06K 9/00771; G06K 9/6257; G06K 9/00671

(57) ABSTRACT

A monitoring and analysis system can display the movements of a person to be monitored using stick figures and without reveling the pictures or identity of the person. The stick figures can be analyzed to detect an unusual or potentially dangerous activity undertaken by the person.

### CROSS-REFERENCE TO RELATED APPLICATIONS

This application claims priority to and benefit of U.S. Provisional Patent Application No. 62/789,217, entitled “Systems and Methods for Monitoring and Recognizing Human Activity,” filed on Jan. 7, 2019, the entire contents of which are incorporated herein by reference.

### FIELD OF THE INVENTION

The techniques described herein are generally related to capturing video images and analyzing them in real time and, in particular, to systems and methods for detecting anomalies in the recoded motion.

### BACKGROUND

A number of elderly people often live by themselves in their own homes. Even those who live at an assisted living facility spend a significant time by themselves in their rooms or apartments. These people are able to move about and undertake many activities such as sitting by a desk and working on a computer, cooking, performing light exercise such as walking on a treadmill. Nevertheless, these elderly people (and also those who may be partially and/or temporarily disabled) can be more susceptible to accidents, falls, and injury. Remotely watching them continuously via video cameras is one way to ensure that help can be provided quickly in case of a fall or an accident, but this can be a serious invasion of a person's privacy. Many people would not be comfortable with such constant, intrusive monitoring.

In the field of computer vision, techniques have been developed for detecting and analyzing motion, and some of these techniques can automatically detect a fall. But, a fall is only one type of dangerous situation. A person sitting on the floor, doing yoga, may sprain a muscle and may need some help. There are some situations where the person is not injured and does not need help, but the situation has a high potential for an accident to occur. For example, a person may be tempted to move a heavy piece of furniture, or may climb on a chair to change a light bulb. In these situations, it may be beneficial to warn that person, so that the person would refrain from undertaking that activity, avoiding the likelihood of an injury. Many known motion analysis techniques cannot identify such special cases or anomalies. Even the fall detection techniques that are generally known today require significant training and, as such, do not detect many different types of falls for which the technique is trained. Improved techniques for motion or activity analysis are therefore needed.

### SUMMARY

In various embodiments, the systems and methods described herein facilitate remotely monitoring a person without displaying actual images of the person, thereby protecting the person's privacy. This is achieved, in part, by displaying stick figures that are associated with the person and that are derived from images of the person. The stick figures are superimposed on the image of the space, such as one or more rooms, hallways, etc., where the person to be monitored is located. The stick figures may also be analyzed using one or more autoencoders to determine whether the person may be undertaking an atypical or a potentially dangerous activity.

Accordingly, in one aspect a method is provided for monitoring or analyzing movements of a person to be monitored. The method includes the steps of: receiving from a sensor an image of the person to be monitored, and generating a stick figure that includes a linking of a number of joints of the person, where the different joints are identified in the image. The method also includes superimposing the stick figure onto a background, where the background includes an image of a space (e.g., a room) within which the person to be monitored is located, and where the image of the space lacks the image of the person and/or images of other persons.

The method may include repeating the receiving, generating, and superimposing steps one or more times with respect to one or more additional images of the person to be monitored. In each repetition, the superimposing step superimposes different stick figure, thus superimposing a sequence of stick figures onto the background, and indicating a movement of the person. In some embodiments, the method includes determining an identity of the person from the image of the person, and associating the identity with each stick figure in the sequence. Determining the identity may include recognition of the face of the person or recognition of the clothing of the person.

In some embodiments, the method includes providing the stick figure as an input to an autoencoder system; comparing a difference between a reconstructed stick figure generated by the autoencoder system and the stick figure provided as the input, with a specified threshold; and based on the comparison, determining whether an action likely undertaken by the person is designated abnormal or dangerous. The autoencoder system may include a first autoencoder for determining a pose of the person; and a second autoencoder for determining the action likely undertaken by the person. The method may include providing a warning to the person when the action likely undertaken by the person is designated abnormal or dangerous. The method may also include providing a pace of movement of the stick figure as another input to the autoencoder system.

In another aspect, a system is provide for monitoring or analyzing movements of a person to be monitored. The system includes a processor in communication with memory, wherein the memory includes instructions which, when executed by a processing unit, program the processing unit to perform one or more operations according to the steps of the methods described above. The processing unit is in electrical communication with a memory module for storing and accessing data generated and required during the performance of the programmed operations. The processing unit may be the same as the processor or may be different from the processor, and the memory unit may the same as the memory or may be different from the memory.

In another aspect, a method is provided for training sets of autoencoders. The method includes the step of: providing a number of stick figures corresponding to an image of a person as inputs to several autoencoders in a first set of autoencoders. Each stick figure may correspond to a respective position of the person with reference to a sensor or within a space. The method also includes determining by each autoencoder in the first set of autoencoders a respective pose of the person; and providing the poses and pace information associated with a movement of the person to a number of autoencoders in a second set of autoencoders. In addition, the method includes determining by each autoencoder in the second set of autoencoders a respective action likely undertaken by the person, and selecting autoencoder weights for minimizing a first error and a second error, wherein the first error is a minimum of differences between an actual pose of the person and respective poses determined by the first set of autoencoders and the second error is a minimum of differences between an actual action undertaken by the person and respective actions determined by the second set of autoencoders. The method may include assigning respective likelihoods to several combinations of positions, pose, and actions of the person.

In another aspect, a system is provide for training sets of autoencoders. The system includes a processor in communication with memory, wherein the memory includes instructions which, when executed by a processing unit, program the processing unit to perform one or more operations according to the steps of the methods described above. The processing unit is in electrical communication with a memory module for storing and accessing data generated and required during the performance of the programmed operations. The processing unit may be the same as the processor or may be different from the processor, and the memory unit may the same as the memory or may be different from the memory.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals/labels generally refer to the same or similar elements. In different drawings, the same or similar elements may be referenced using different reference numerals/labels, however. The drawings are not necessarily to scale, emphasis instead being placed upon illustrating aspects of the invention. In the drawings:

FIG. 1 depicts a stick figure superimposed on a picture of a room, according to one embodiment;

FIG. 2 depicts a sequence of stick figures indicating movement of a person, according to one embodiment; and

FIG. 3 schematically depicts sets of autoencoders used in training an autoencoder, according to one embodiment.

### DETAILED DESCRIPTION

Various embodiments of a home care system described herein facilitate round the clock monitoring of the occupants of a home and detecting circumstances where it may be necessary to provide assistance to a person for that person's safety. The computer vision based detection minimizes or avoids the need for constant monitoring by someone else, which can not only be cost effective but can also effectively protect user privacy.

Embodiments of the home care system include one or more of the following components:
(A) A set of video and/or audio sensors mounted in a dwelling, e.g., on the doors, that send their streams to a processor unit that may also be located in the same dwelling.
(B) A processor unit that processes the video and/or audio streams to extract information about a person that is monitored and to detect anomalies in the pose (posture) and/or movement of the person. The anomaly can indicate that the person may have fallen down, or is unable to move about, etc., and may need assistance. The extracted information about anomalies may not include the actual videos and, as such, can protect the monitored persons' privacy.
(C) A web-server that performs the front-end role for caregivers such as organizations providing care and services to the elderly or those who need assistance, and/or individuals who provide such care. A web-server may also maintain a notification system and an event-archive.
(D) A training “back-end” system that may be connected to the web-server. The back-end system allows labeling of all archived information for retraining and/or testing/validating one or more trainable algorithms used in the overall system, and/or for testing/validating on or more non-trainable algorithms used in the overall system.

The sensors can be video cameras or stereo-video cameras that may optionally have microphones. The non-stereo video cameras can be more autonomous. For example, they may be powered by batteries. Stereo-cameras provide a three-dimensional (3D) estimation of a room's environment, and allow the extraction of objective information about a human's poses in a captured frame. Sometimes “pose” means the combination of the position and orientation of an object in an image with reference to a selected coordinate system. As used herein, pose generally means the posture of the person at a particular position on the floor, such as standing up, standing up with arms raised, bending down, kneeling, sitting down, laying down, etc.

In various embodiments, the processing unit is programmed to perform one or more of the following processes:
Pose detection based on a deep-learning trained convolutional neural network, that takes into consideration consistency of input frames and possible changes in a monitored person pose due to the person's movements.
Person's reidentification based on his or her appearance, such as reidentification using a person's cloths, hair, certain body characteristics, etc.
Person's identification via face recognition.
Persons' tracking algorithm that uses the identification information that allows sewing tracks in cases of obstacles and detection losses. Obstacles can be objects in a room or other persons in the room that would block the images captured from the tracked person. As such, the images associated with a tracked person may be distributed across two or more groups of frames. These frames/frame groups can be assembled or “sewed” together using the identity information.
Background extraction algorithm. Background extraction may be used for enhancing the pose detection and for providing visualization of a person's movement using “stick” figures, and/or to perform analysis of such a movement.
Algorithm that tracks appearance and disappearance of a tracked person when that person passes from the viewing area of one camera to another, e.g., when the person moves from one room to another, or goes to bed.
Detecting visitors, e.g., to distinguish between a monitored person and those who are not monitored.
Identifying the types of activities, such as sitting at a table, sitting on the floor, walking about, etc. The identification is based on a set of autoencoders and allows a “few-shots learning” by labeling data in the training “back-end.” Few-shots learning is a supervised part of training that may be performed just after a substantial unsupervised learning phase. This approach can also reveal undetermined activities that may be anomalies. Such anomalies can indicate an activity of a monitored person where it may be beneficial to intervene and/or to provide assistance. For example, a person may be attempting to move a heavy piece of furniture or may be climbing up on a chair to change a light bulb. If the person is elderly and does not normally undertake such activities, it may be beneficial to warn that person or a caregiver.
Detection of falls using a recurrent-neural network.
3D estimation of pose for accurate detection of a fall.

The processing unit may also implement one or more the following subsystems:
Calculation subsystem;
Subsystem for saving and maintaining of archives; and
Information exchange subsystem.

The web-server(s) implements the front-end of the system, so as to perform one or more of the following functions:
Providing user-access rights.
Streaming “stick-figures” videos to other user applications upon requests, as described below.
Notify users, e.g., monitored persons and/or caregivers of alarm-events, e.g., events associated with detected anomalies and/or falls.
Inspecting and/or summarizing events history and statistics.
Showing the current state of one or more monitored rooms, where the identity of a monitored person is provided and his or her current activity is identified.
Providing a statistical analysis of persons, their activities, and events over time.

There are a lot of privacy concerns and discomfort for people when they know that they are under video surveillance. To reduce this discomfort we created a way to hide sensitive data about peoples' identities. This techniques helps us show important information about the people who are monitored, e.g., to check where somebody is or to check what that person is doing, but not to too much to become intrusive to the privacy of that person.

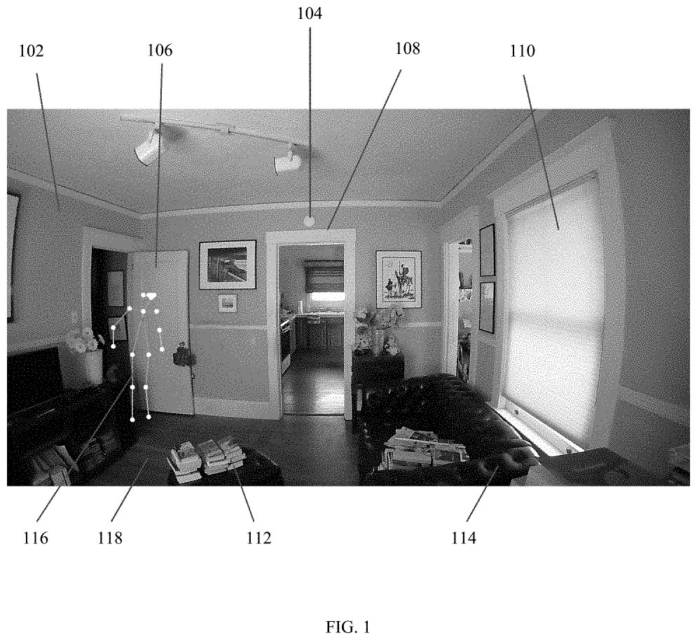

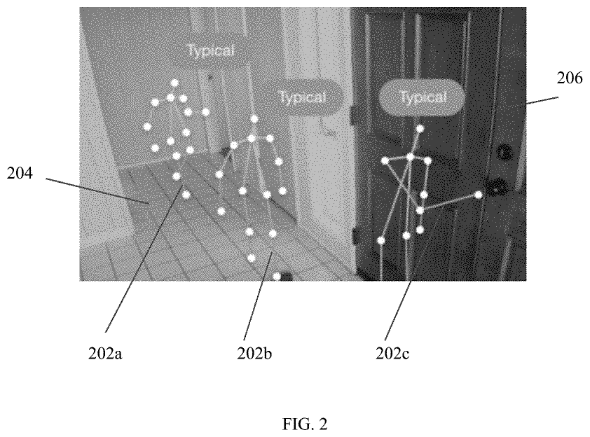

With reference to FIG. 1, we use “skeleton view” or “stick-figures”—the result from the pose estimation process and put it on the static background of a room. As an example, the room 102 has installed therein a sensor 104. The sensor 104 may include a camera, a stereo camera, a 3D camera, an infra-red camera, an audio sensor, or a combination of two or more cameras and/or audio sensors. The room 102 has two doors 106, 108 and a window 110. Among other objects, the room 102 has a table 112 and a couch 114. A person indicated by the stick FIG. 116 is present in a corner of the room 102. The pose estimation has determined that the person is standing straight on the floor 118 of the room 102, and orientation determination indicates that the person is facing into the room 102. With reference to FIG. 2, a person represented by stick FIGS. 202a-c is walking in a hallway 204 and is attempting to open the door 206.

This process can be applied to a static image or to a video stream. In a video stream, the background image can be changed if the system does not detect a person in the field of view. The background image may also be changed by segments when the background does not include a privacy-sensitive picture of human.

The process generally involves the following steps:

1. Get a video stream from a camera

2. Extract “skeletons”

3. Capture background without humans

4. Add skeletons to the background and combine to form a video stream for rendering.

The camera can be switched to the private mode or to the ordinary video mode, via an app or by using a physical switch on the camera.

The training “back-end” module, in various embodiments closes the loop for trainable algorithms and also allows controlling the current state of non-trainable algorithms for maintaining and/or improving the quality of the overall system. For example, while an unsupervised algorithm cannot be trained, labeled training datasets and the results of the algorithm can be used to improve the accuracy of the algorithm, e.g., by adjusting one or more algorithm parameters. The back-end module allows supervisors to label and control the following parameters:
A person's joints in a captured frame.
A person's identity.
Type of the current activity for each person that is monitored.

The back-end module also allows a supervisor to:
Initiate tests for controlling the current state of non-trainable and trainable algorithms
Initiate the retraining procedure for one or more trainable algorithms.

Modern deep-learning (DL) algorithms for activity detection/classification, such as recurrent neural network (RNN), are often not well suited for anomaly detection because they require a significant amount of data for training, which is often not available. These algorithms are also not particularly stable with respect to new, unexpected conditions, e.g. when an new, unexpected activity takes place. Detection of anomalous activities, where an RNN does not have adequate internal pre-trained models and, hence, cannot perform such a detection accurately, may be important however, to ensure or improve a monitored person's safety.

Tasks of classification and parameter estimation have probabilistic background that is the Bayesian Decision Theory and Bayesian estimation. The probability density function (PDF) plays a very important role in the Bayesian decision theory. It is required to know the PDF of input data for calculation a posteriori risk in choosing the best decision in classification tasks, where the input data is classified into two or more classes.

Autoencoders are well suited for estimating of the PDF of input data. An autoencoder includes an encoder and a decoder. The encoder encodes, i.e., transforms input data into a latent-space representation (also called a latent vector or code) typically having a lower dimension than that of the input data. The code can indicate certain latent information about, e.g., certain properties or characteristics of, the input data. The decoder receives the latent-space representation and reconstructs the input data, which is provided as the output of the autoencoder. Due to the reduction in dimensionality, the reconstruction is typically not perfect, i.e., the output is different from the input. During training, where in the input is known, the difference between the input and output can be minimized by adjusting the weights of the autoencoder. In general, the training data set is assumed to define the probability density of the input data. By obtaining latent representations (also called latent vectors, models, or codes) of input data for each class or for some points in the space of parameters in a parameter estimation task, we can estimate likelihood functions or PDFs for those classes or points in parameter space.

Thus, the more the training samples are placed around a point in the input space, the better the autoencoder will reconstruct the input there. Also, as there is a latent vector in the bottleneck of the autoencoder, if an input vector is projected to the area in the latent space that was not involved previously in training, then this input vector can be determined to be unlikely. An unlikely input vector can also indicate an anomaly.

### Single Autoencoder

Consider an arbitrary autoencoder x*=f(g(x)), where g(x) is the encoder; f(z) is the decoder. The encoder projects the input space to the corresponding latent space. A probability density function for x ∈ X and z ∈ Z is equal to:

p(x)=∫_{z}p(x|z)p(z)dz (1)

One of our goals is to obtain a relationship between p(x) and p(z). For simplicity, let us assume that the input vector x is presented as x=f(g(x))+n after autoencoder training, where n is gaussian noise. There is a latent model, z, that we can derive, for example, by training a multiple-layer neural network. Then the noise distribution n=f(z)−x with the deviation σ is:

$$p ( n ) = const \times exp ( - \frac{{( x - f ( z ) )}^{T} ( x - f ( z ) )}{2 {σ}^{2}} ) = p ( x \vert z ) \qquad ( 2 )$$

(x−f(z))^{T} (x−f(z)) is the distance between x and its reprojection through the latent space back to X. This distance reaches its minimum value at some point z*. Partial derivatives of the exponents argument in Equation (2) will be zero in the direction zᵢ where zᵢ are axes in Z.

Choosing the point where the distance ∥x−f(z)∥(i.e., the least square error or L2 error) has its minimum value is founded on the weights optimization of the autoencoder. As such, while training, least square error (L2) loss between input and output is minimized for all train samples by adjusting the weights of the autoencoder:

$${min}_{θ , ∀ x ∈ X train} ‖ x - {f}_{θ} ( {g}_{θ} ( x ) ) ‖$$

where θ are the autoencoder's weights.

After successful autoencoder training, the selected weights bring g(x) to the optimal output z*, and we can consider this as an estimation. We can also represent f(z) through the first Taylor member around z* in Equation (2) as:

f(z)=f(z*)+∇f(z*)(z−z*)+o((z−z*))

Therefore, Equation (2) can now be written as:

$$P ( x \vert z ) \approx const \times exp ( - \frac{\begin{matrix}{( ( x - f ( {z}^{*} ) ) - ∇ f ( {z}^{*} ) ( z - {z}^{*} ) )}^{T} \\ ( ( x - f ( {z}^{*} ) ) - ∇ f ( {z}^{*} ) ( z - {z}^{*} ) )\end{matrix}}{2 {σ}^{2}} ) = const \times exp ( - \frac{{( x - f ( {z}^{*} ) )}^{T} ( x - f ( {z}^{*} ) )}{2 {σ}^{2}} ) exp ( - \frac{{( ∇ f ( {z}^{*} ) ( z - {z}^{*} ) )}^{T} ( ∇ f ( {z}^{*} ) ( z - {z}^{*} ) )}{2 {σ}^{2}} ) \times \times exp ( - \frac{\begin{matrix}( ∇ {f ( {z}^{*} )}^{T} ( x - f ( {z}^{*} ) ) + \\ {( x - f ( {z}^{*} ) )}^{T} ∇ f ( {z}^{*} ) ) ( z - {z}^{*} )\end{matrix}}{2 {σ}^{2}} )$$

Note that the last multiplier is equal to 1 according to Equation (3). The first multiplier does not depend on z and can be brought outside the integral. Another assumption we make is that p(z) is a smooth function and it can be replaced by p(z*) around z*. With these assumptions, the integral of Equation (1) can be estimated as:

$$p ( x ) = const \times p ( {z}^{*} ) exp ( - \frac{{( x - f ( {z}^{*} ) )}^{T} ( x - f ( {z}^{*} ) )}{2 {σ}^{2}} ) {\int }_{z} exp ( - {( z - {z}^{*} )}^{T} {W ( x )}^{T} W ( x ) ( z - {z}^{*} ) ) dz , {z}^{*} = g ( x )$$

$$where W ( x ) = \frac{∇ f ( {z}^{*} )}{σ} , {Z}^{*} = g ( x ) .$$

The last integral is the n-dimensional Euler-Poisson integral:

$${\int }_{z} exp ( - \frac{{( z - {z}^{*} )}^{T} {W ( x )}^{T} W ( x ) ( z - {z}^{*} )}{2} ) dz = \sqrt{\frac{1}{det ( {W ( x )}^{T} W ( x ) / 2 π )}}$$

Therefore, the distribution p(x) has the following approximation:

$$p ( x ) = const \times exp ( - \frac{{( x - f ( {z}^{*} ) )}^{T} ( x - f ( {z}^{*} ) )}{2 {σ}^{2}} ) p ( {z}^{*} ) \sqrt{\frac{1}{det ( {W ( x )}^{T} W ( x ) / 2 π )}} , {z}^{*} = g ( x ) \qquad ( 4 )$$

We have thus shown that the input data distribution p(x) can be estimated by multiplication of three factors:

1. The distance between the input vector and its reconstruction

2. The distribution p(z) at the projected point z*=g(x)

3. The integral value, that is calculated directly from autoencoder's weights

An advantage of using autoencoders is that it is possible to detect anomalies: if reconstruction of input data was wrong or projection to the latent space had not appeared previously, then it may be inferred that the input was an anomaly. For example, an autoencoder may accurately reconstruct an action such as walking about in a room, standing up, sitting on a chair, etc., but may not reconstruct, at least as accurately as other actions, actions such as falling down or climbing up on a chair. Such actions may then flagged as anomalous.

### Sharing the Latent Space

By training an autoencoder, we are trying to receive “treatment” of the input data, that describes the input data sufficiently for the reconstruction. In the case of using a set of autoencoders it may be that this treatment can be the same for different autoencoders. For example, in a computer vision task we can define each autoencoder for a corresponding orientation and, thus, the context of each autoencoder is the respective orientation of the input image. A point in the latent space of an autoencoder defines the properties of an object in the field of view. As those properties are actually the same for all orientations of that object, the respective representations of the same object in the respective latent spaces of different autoencoders is expected to be the same. This observation helps improve the estimation of p(z) in Equation (4), and also allows the extraction of latent information about or certain characteristics of the input data. The estimated distribution of p(z) may be shared for all autoencoders in a set of autoencoders. All training samples corresponding to different contexts (e.g., different orientations, per the example described above) are projected into the same latent space Z. This provides transfer of samples across different contests that allows one-shot or few-shot learning.

### Cross-Training Procedure in Training of the Set of Autoencoders

Conventionally, to train an autoencoder, known data (e.g., an image) is provided as input to the encoder of the autoencoder. The encoder generates a representation of the input in the latent space, usually of a lower dimensionality, and the decoder of the autoencoder reconstructs the input using the representation thereof in the latent space, to provide an output. The difference between the known input data and the reconstructed output is computed, and the weights of the autoencoder are adjusted such that the difference is minimized.

In cross training a set of autoencoders, the latent-space representation (also called latent code or code) generated by one autoencoder in the set is provided to the decoder(s) of one or more other autoencoders in the set, where such decoder(s) reconstruct the input data from the provided latent code. While the input data provided to all the autoencoders in the set is the same, the context of the input data (e.g., the orientation of an image, per the example described above) can be different for different autoencoders. As such, one or more autoencoders (specifically, the decoders therein) are tasked with reconstructing the input data in different contexts from those of such autoencoders. Thus, this pipeline translates an input from one context to another. Regular self-training steps, where the respective decoder in each autoencoder in the set decodes the latent-space representation generated by the corresponding encoder only, may be mixed with cross-training steps. Thus, all (or several) autoencoders in a set may receive shared latent space or “treatment,” i.e., the latent space of one or more other autoencoders in the set and, as such, can share different contexts.

### One-Shot or Few-Shot Learning

In some cases it is desirable to operate with latent codes ignoring the context. This allows us to recognize a pattern in different contexts if it was demonstrated only in one of them. The sharing of contexts described above, facilitates one-shot or few-shot learning because rather than training a single autoencoder using different inputs, each input being provided in several different contexts, the set of autoencoders is trained such that each autoencoder in the set is provided with the different inputs, but each input is provided to a particular autoencoder in only one context. Cross-training via the shared latent space nevertheless allows the autoencoders in the set to learn to perform reconstruction regardless of the context, thus avoiding the need to train a particular autoencoder to train not only using a number of training inputs but also by providing each input in several different contexts.

### Sets of Autoencoders for Action Determination/Classification

In various embodiments, we use sets of autoencoders, where each set has two or more encoders, with shared latent spaces. Each autoencoder describes the input data in its context. The code (i.e., the set of neurons) inside the autoencoders that is “latent” or hidden is the “treatment” of the input data in the provided context. Each autoencoder estimates the likelihood function that corresponds to the probability of the treatment in that particular context. The terms context and treatment are further described using face recognition as an example.

For the task of face recognition, the input data (e.g., images) are human faces. The following two different approaches can be considered. In the first approach, the context is face orientation. In this case, reconstruction of an input image involves a “treatment” that provides identification of the face. As such, during training we show the same face from different directions or orientations to “freeze” i.e., determine or detect the identity of the face (i.e., the latent code). In the second approach, the context is the identity of the face. In this case, an accurate reconstruction of an input image requires determining the orientation of the face and, therefore, involves a treatment that provides the orientation of the face. As such, during training we show different faces from the same direction, to determine or detect the orientation of the face, which is the latent code in this case. An optimal Bayesian decision, e.g., likelihood, may be chosen in regard to face's orientation in the first case, and in regard to face's identity in the second case.

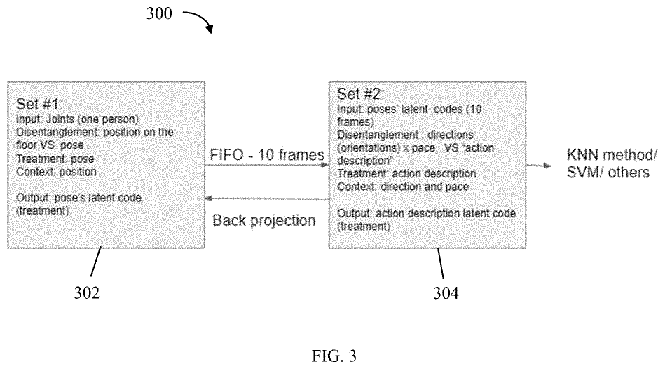

With reference to FIG. 3, an example architecture 300 includes two sets of autoencoders Set #1 302 and Set #2 304. Other architectures may include more than two, e.g., 3, 5, etc., sets of encoders. The architecture 300 (and other architectures, having more than two sets, as well) allow us to disentangle certain pose parameters via a cross-training procedure and to estimate likelihood functions for choosing the best matching estimation of these parameters. To this end, each autoencoder in Set #1 302 receives as input a stick figure derived from the key points or joints in an image of a person. The joints may include certain parts of the body such as shoulders, ankle, knee, wrist, etc. that are identified in the captured image. The context for all of the autoencoders in Set #1 302 is the position of the input stick figure on the floor, and the treatment yields the pose, e.g., the posture of the person associated with the input stick figure and/or the orientation of the person.

Each autoencoder in Set #1 302 corresponds to a respective position on the floor of the input stick figure. The input stick figure is reconstructed by each autoencoder and, during this procedure, we receive the estimation of the likelihood function for each position on the floor (for each autoencoder), so that the best position (context) and pose (treatment) that corresponds to the input stick figure placed in that position and pose can be selected. In general, this process is called “disentanglement” where the stick figure pose description (i.e., code) and stick figure position (i.e., context) are disentangled.

The input to each of the autoencoders in the second set of autoencoders Set #2 304 includes two components. The first component is the latent code, i.e., pose, derived by the corresponding autoencoder in Set #1 302, or by another autoencoder in Set #1 302. The second component of the input is the pace at which the position is changing, e.g., because the person is moving about. In some cases, the person may be falling down. The pace information may be derived from several frames e.g., 4, 5, 10, 12, 15, or more frames. The treatment yields the latent code for Set #2 304 that indicates the action that is likely undertaken by the person associated with the stick figure, such as opening a door, sitting down on a couch, getting up from a chair, climbing on a chair, falling down, etc.

The latent code for Set #2 304 may be classified further, e.g., using a machine learning technique such as a K nearest neighbor neural network (KNN), a support vector machine (SVM), etc., to determine whether the action undertaken by the person is a normal activity, an acceptable activity, a dangerous activity (such as climbing on a chair with arms raised, pushing a heavy object, etc.), or an activity indicating that the person may need help (e.g., kneeling on the floor, laying down on the floor, etc.). The machine learning techniques may be replaced by another set of autoencoders where each autoencoder in the third set (not shown) estimates the probability for each type of identified activity. An alarm may be raised if an activity having a low probability is detected, as such an activity is not likely as part of the routine or typical behavior of the monitored person.

In some cases, for providing one-shot or a few-shots learning, the following training procedure may be used:
1st stage: 110 000 3D poses from a motion capture dataset were projected to the frame at different positions on the floor to provide cross-training and disentanglement of position and poses' codes. Data labeling may not be used in this phase of training.
2nd stage: 57 animations were projected to the frame in different directions with different paces at one position, so the latent code presented the type of action. The animation describes a sequence of poses. Data labeling may not be used at this stage either.
3d stage: for example, once getting up from a chair was shown, the latent code of this action from the set #2 output was saved. Recognition of the action was performed by threshold comparison of the set #2 output and the only saved code. During recognition it is determined how closely a particular treatment corresponds to a known (labeled) sample.

Thus, the autoencoder-based technique performs at least the following functions:
Estimation of probabilities for each type of activity;
Detecting anomalies, that are cases when input data cannot be described at least in one of sets of autoencoders; and
Estimation of the following parameters for each frame or track: person's position on the floor, orientation, and pace. Examples of position include “near the door,” “by a window,” etc. Examples of orientation include looking in a particular direction. Examples of pose include “standing straight,” “standing with hands raised,” etc.

In some embodiments, during the estimation of parameters we utilized the potential of sets of autoencoders to back-project treatments to an underlying set of autoencoder. Therefore, assuming the type of activity, we reject possibilities in the underlying level that correspond to disentanglement of “pose-animation” and orientation. As such, we have a more precise estimation of the orientation. The orientation can then be projected to the level #1, where pose and the person's position on the floor are disentangled. As such, the precision of determining positions can be improved.

Once the training is complete, a system of autoencoders can be configured similar to the architecture 300, except, instead of sets of autoencoders, the system includes only a pair of autoencoders. The first autoencoder in the pair is configured similar to the autoencoders in Set #1 302, i.e., the first autoencoder can receive a stick figure corresponding to a person's image, where an activity of the person is to be analyzed. The first autoencoder can determine the pose of the person. The pose and pace information (obtained from a sequence of images/frames of images of the person) are provided to the second autoencoder in the pair, which can determine the action likely undertaken by the person. The weights of the first and second autoencoders can be set to the weights determined to optimal for the first and second sets of autoencoders during the training phase.

As one application of the techniques described above, a procedure for detecting the fall of the elderly with high accuracy is described below. This procedure involves synthesis of dangerous situations, and further training of the algorithms using the synthesized situations. One significant problem of many medical data processing tasks is the high complexity of their markup or labeling. But, training generally cannot be performed without such markup. Typically, tens of thousands of examples are needed to train a neural network to detect falls. Such a dataset is very difficult, if not impossible to obtain in practice. One important obstacle is in real conditions, one fall of an elderly person can already be a tragedy, so several falls cannot be orchestrated so that substantial training data would become available. Even if a young person is recruited to record falls, not more than a few falls can be orchestrated and recorded in a day without the danger of that person getting injured.

Therefore, we have developed an approach that allows obtaining synthetic data for training a neural network, where such data may be indistinguishable from the data associated with real falls. Using synthesized data, a large training dataset can be created very quickly, without causing injuries to anyone. The synthesis of the training data is based on the following two features:

First, we work only with a selected human skeleton. The human skeleton may be extracted from a video stream using an available pose estimation software. The result of the selection of the skeleton is a set of “joints”—limbs that correspond to the human body. Second, we synthesize falls in the form of skeletons using known MotionCapture techniques. We collected 150 falls examples using MotionCapture, and also captured a set of situations/motions that are not falls. These 150+ examples were applied to the skeletons to simulate or synthesize several different falls, e.g., in different directions, of the person from the video images of whom the skeleton was obtained.

In the course of training, the allowable position of the camera (i.e., the relative position of a person and a camera) were selected. The cameras were set up as they usually are in dwellings. For each such camera, animations of the person to be monitored falling were generated for different heights and widths of the skeleton. Simulated noise, e.g., in the form of missing/hidden joints, wrong position of joints, frame drops in the sequence of the video stream, etc., were added to the animations. A recurrent neural network was trained on the resulting skeleton base.

This method allows the system to learn from mistakes. If at some action the neural network produced an erroneous result, it was enough to ask the actor to repeat only that action in order to add the problem action to the skeleton base used for training. Examples derived directly from the video may also be used to minimize recognition errors.

In some examples, some or all of the processing described above can be carried out on a personal computing device, on one or more centralized computing devices, or via cloud-based processing by one or more servers. In some examples, some types of processing occur on one device and other types of processing occur on another device. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

A computing system used to implement various embodiments may include general-purpose computers, vector-based processors, graphics processing units (GPUs), network appliances, mobile devices, or other electronic systems capable of receiving network data and performing computations. A computing system in general includes one or more processors, one or more memory modules, one or more storage devices, and one or more input/output devices that may be interconnected, for example, using a system bus. The processors are capable of processing instructions stored in a memory module and/or a storage device for execution thereof. The processor can be a single-threaded or a multi-threaded processor. The memory modules may include volatile and/or non-volatile memory units.

The storage device(s) are capable of providing mass storage for the computing system, and may include a non-transitory computer-readable medium, a hard disk device, an optical disk device, a solid-date drive, a flash drive, or some other large capacity storage devices. For example, the storage device may store long-term data (e.g., one or more data sets or databases, file system data, etc.). The storage device may be implemented in a distributed way over a network, such as a server farm or a set of widely distributed servers, or may be implemented in a single computing device.

The input/output device(s) facilitate input/output operations for the computing system and may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices. In some examples, mobile computing devices, mobile communication devices, and other devices may be used as computing devices.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium.

Various embodiments and functional operations and processes described herein may be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

The phraseology and terminology used herein is for the purpose of description and should not be regarded as limiting. The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A method for monitoring or analyzing movements of a person to be monitored, the method comprising the steps of:
receiving from a sensor an image of the person to be monitored;
generating a stick figure comprising a linking of a plurality of joints of the person, the plurality of joints being identified in the image; and
superimposing the stick figure onto a background, the background comprising an image of a space within which the person to be monitored is located, the image of the space lacking the image of the person or images of other persons.

2. The method of claim 1, further comprising:
repeating the receiving, generating, and superimposing steps one or more times with respect to one or more additional images of the person to be monitored,
wherein the superimposing step superimposes a sequence of stick figures onto the background and indicates a movement of the person.

3. The method of claim 2, further comprising:
determining an identity of the person from the image of the person; and
associating the identity with each stick figure in the sequence

4. The method of claim 3, wherein determining the identity comprises recognition of face of the person or recognition of clothing of the person.

5. The method of claim 1, further comprising:
providing the stick figure as an input to an autoencoder system;
comparing a difference between a reconstructed stick figure generated by the autoencoder system and the stick figure provided as the input, with a specified threshold; and
based on the comparison, determining whether an action likely undertaken by the person is designated abnormal or dangerous.

6. The method of claim 5, wherein the autoencoder system comprises:
a first autoencoder for determining a pose of the person; and
a second autoencoder for determining the action likely undertaken by the person.

7. The method of claim 5, further comprising providing a waring to the person when the action likely undertaken by the person is designated abnormal or dangerous.

8. The method of claim 5, further comprising providing a pace of movement of the stick figure as another input to the autoencoder system.

9. A method for training sets of autoencoders, the method comprising the steps of:
providing a plurality of stick figures corresponding to an image of a person as inputs to a plurality of autoencoders in a first set of autoencoders, wherein each stick figure corresponds to a respective position of the person with reference to a sensor or within a space;
determining by each autoencoder in the first set of autoencoders a respective pose of the person;
providing the poses and pace information associated with a movement of the person to a plurality of autoencoders in a second set of autoencoders;
determining by each autoencoder in the second set of autoencoders a respective action likely undertaken by the person; and
selecting autoencoder weights for minimizing a first error and a second error, wherein the first error is a minimum of differences between an actual pose of the person and respective poses determined by the first set of autoencoders and the second error is a minimum of differences between an actual action undertaken by the person and respective actions determined by the second set of autoencoders.

10. The method of claim 9, further comprising assigning respective likelihoods to a plurality of combinations of positions, pose, and actions of the person.

11. A system for monitoring or analyzing movements of a person to be monitored, comprising:
a processor; and
a memory in communication with the processor and comprising instructions which, when executed by a processing unit in communication with a memory unit, program the processing unit to:
receive from a sensor an image of the person to be monitored;
generate a stick figure comprising a linking of a plurality of joints of the person, the plurality of joints being identified in the image; and
superimpose the stick figure onto a background, the background comprising an image of a space within which the person to be monitored is located, the image of the space lacking the image of the person or images of other persons.

12. The system of claim 11, wherein the instructions further program the processing unit to:
repeat the receive, generate, and superimpose operations one or more times with respect to one or more additional images of the person to be monitored,
wherein the superimposing operation superimposes a sequence of stick figures onto the background and indicates a movement of the person.

13. The system of claim 12, wherein the instructions further program the processing unit to:
determine an identity of the person from the image of the person; and
associate the identity with each stick figure in the sequence.

14. The system of claim 13, wherein to determine the identity, the instructions program, the processing unit to recognize face of the person or to recognize clothing of the person.

15. The system of claim 1, further comprising:
an autoencoder system,
wherein the instructions program the processing unit to:
provide the stick figure as an input to the autoencoder system;
compare a difference between a reconstructed stick figure generated by the autoencoder system and the stick figure provided as the input, with a specified threshold; and
based on the comparison, determine whether an action likely undertaken by the person is designated abnormal or dangerous.

16. The system of claim 15, wherein the autoencoder system comprises:
a first autoencoder for determining a pose of the person; and
a second autoencoder for determining the action likely undertaken by the person.

17. The system of claim 15, wherein the instructions program the processing unit to operate as the autoencoder system.

18. The system of claim 15, wherein the instructions further program the processing unit to provide a warning to the person when the action likely undertaken by the person is designated abnormal or dangerous.

19. The system of claim 15, wherein the autoencoder system is programmed to receive a pace of movement of the stick figure as another input.

20. A system for training sets of autoencoders, comprising:
a processor; and
a memory in communication with the processor and comprising instructions which, when executed by a processing unit in communication with a memory unit, program the processing unit to:
provide a plurality of stick figures corresponding to an image of a person as inputs to a plurality of autoencoders in a first set of autoencoders, wherein each stick figure corresponds to a respective position of the person with reference to a sensor or within a space, wherein:
each autoencoder in the first set of autoencoders is configured to:
determine a respective pose of the person; and
provide the poses and pace information associated with a movement of the person to a plurality of autoencoders in a second set of autoencoders;
each autoencoder in the second set of autoencoders is configured to determine a respective action likely undertaken by the person; and
select autoencoder weights for minimizing a first error and a second error, wherein the first error is a minimum of differences between an actual pose of the person and respective poses determined by the first set of autoencoders and the second error is a minimum of differences between an actual action undertaken by the person and respective actions determined by the second set of autoencoders.

21. The system of claim 20, wherein the instructions further program the processing unit to assign respective likelihoods to a plurality of combinations of positions, pose, and actions of the person.
